(19) United States
(12) Patent Application Publication
(10) Pub. No.: US 2006/0035200 A1
(43) Pub. Date: Feb. 16, 2006

(54) NutriMeter

(75) Inventor: Dorinda Geans Pittman, Jacksonville, FL (US)

Correspondence Address: Dorinda Geans Pittman, 4620 Sunbeam Station Court, Jacksonville, FL, 32257, US

(73) Assignee: Ms. Dorinda Geans Pittman, Jacksonville, FL (US)

(21) Appl. No.: 10/710,980

(22) Filed: Aug. 16, 2004

(51) Int. Cl. G09B 19/00

(52) U.S. Cl. 434/127

(57) ABSTRACT

What is new to the public is the entire NutriMeter system. The NutriMeter is a software package that will allow users to enter their daily food, vitamin, and drink consumption and receive a report of their nutrional intake and suggestions on additional intake to be at the recommended level for their age, size, and medical status. The package will be able to scan in scan friendly nutrional charts and read the information of the food consumed and add that information to a persona's daily intake or to the main database for future use. In the future the software package can be downloaded to PDA's.

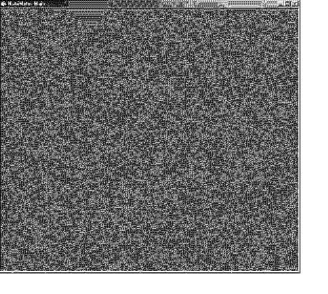

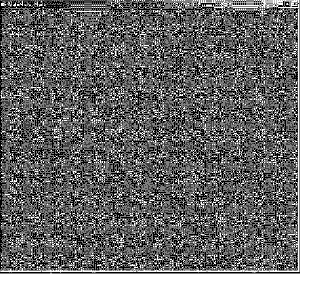

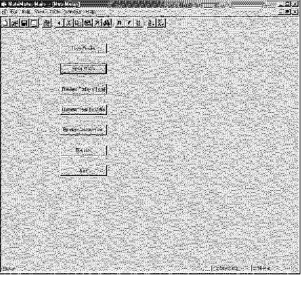

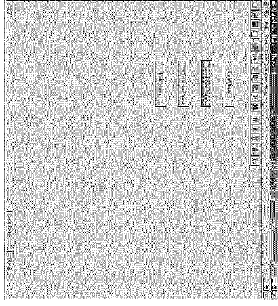

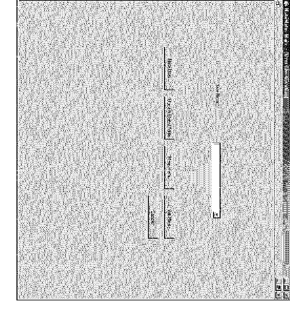

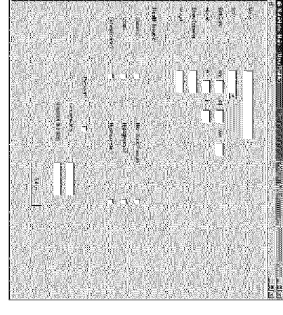

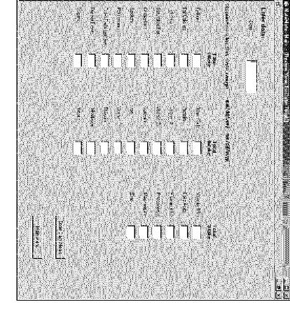

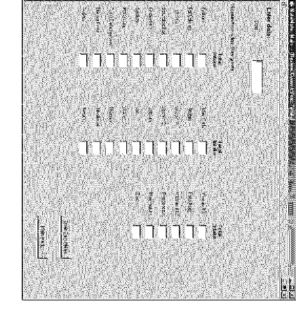

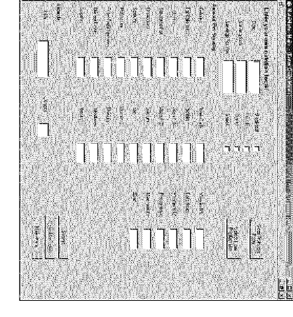

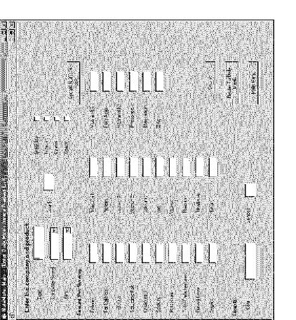

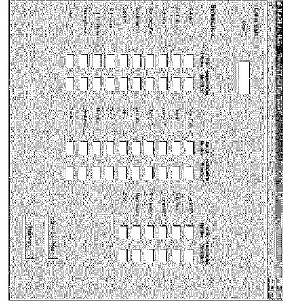

### BACKGROUND OF INVENTION

The NutriMeter was invented in 2002 by Dorinda K. Pittman to revolutionize the health conscience world. The application is far from complete, but with additional funds and technology assistance, the NutriMeter will be in every home.

### SUMMARY OF INVENTION

The NutriMeter will allow users to track their daily, weekly, monthly, or annually intake of nutrients based on their weight, sex, and health status (i.e. diabetic, pregnant, etc.). The NutriMeter will calculate the current nutrients a person intakes, and inform them of deficient areas.

### DETAILED DESCRIPTION

The NutriMeter is a Visual Basic Program that will (with upgrades) accept uploads from Palm PC's and downloads from food preparation companies. The system will also (with upgrades) scan a Nutritional Chart into it's database.

What I claim as my invention is:

1. The NutriMeter is a software package that will allow users to enter their daily food, vitamin, and drink consumpion and receive a report of their nutrional intake and suggestions on additional intake to be at the recommended level for their age, size, and medical status. The package will be able to scan in scan friendly nutrional charts and read the information of the food consumed and add that information to a personal's daily intake or to the main database for future use. In the future the software package can be downloaded to PDA's.
